(19) United States
(12) Patent Application Publication
(10) Pub. No.: US 2021/0082073 A1
(43) Pub. Date: Mar. 18, 2021

(54) SYSTEMS AND METHODS OF SELECTING TRANSPORTATION MODES FOR TRANSPORTATION NEEDS

(71) Applicant: Ford Global Technologies, LLC, Dearborn, MI (US)

(72) Inventors: Jose Garcia Crespo, Bloomfield Township, MI (US); Naval Goel, Spring, TX (US); Vinay Nihalani, Sugar Land, TX (US)

(73) Assignee: Ford Global Technologies, LLC, Dearborn, MI (US)

(21) Appl. No.: 16/570,986

(22) Filed: Sep. 13, 2019

(51) Int. Cl. G06Q 50/30; G06Q 30/06; G06N 5/04

(52) U.S. Cl. CPC G06Q 50/30; G06N 5/045; G06Q 30/0631

(57) ABSTRACT

Methods and systems for improving the selection of transportation methods are provided herein. An example method includes receiving information associated with a transportation need, ranking a plurality of mobility attributes associated with the transportation need, performing quantitative modeling and multiple-criteria decision making (MCDM) analysis and linear programming using the ranking of the plurality of mobility attributes and available transportation modes, and ranking the available transportation modes for the transportation need in view of results from the linear programming and MCDM analysis.

### TECHNICAL FIELD

The present disclosure relates to systems and methods of selecting transportation modes for transportation needs and more particularly to multiple-criteria decision making (MCDM) analysis and linear programming to optimize a ranking of a plurality of transportation modes for a transportation need based on a ranking of mobility attributes associated with the transportation need and available transportation modes.

### BACKGROUND

There are approximately 270 million vehicles in the United States. Over the last few years, about 17 million vehicles were sold annually. Of these new vehicles, approximately 2% are electric vehicles or hybrid vehicles and the remaining 98% use internal combustion engines running on either gasoline or diesel fuel.

Consumer transportation decisions include whether to purchase or lease vehicles, utilize public transportation systems (e.g., trains and buses), call a taxi, or hail a ride using a third-party driving service. In determining which mode of transportation is best suited for each individual, there are several conflicting requirements depending on the transportation needs of that individual. For example, for individuals commuting to work, the most pressing need might be a reliable and cost-effective transportation solution. The individual may be willing to forego certain transportation attributes such as family-size capacity in view of a more compact, budget friendly alternative. Alternatively, for household needs such as grocery shopping or general consumer shopping, the needed transportation solution may be different. Household needs may be better suited, for instance, in view of social and family needs.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to sale. Throughout this disclosure, depending on the context, singular and plurality terminology may be used interchangeably.

FIG. 1 depicts a transportation system in accordance with an embodiment.

FIG. 2 depicts an illustrative listing of transportation needs to be evaluated for different transportation modes in accordance with an embodiment.

FIG. 3 is a decision-making matrix utilized to rank transportation modes in accordance with an embodiment.

FIG. 4 is a ranking of mobility attributes for various transportation needs in accordance with an embodiment.

FIG. 5 is a ranking of transportation modes for each mobility attribute in accordance with an embodiment.

FIG. 6 is a ranking of mobility attributes for each of the transportation needs in accordance with an embodiment.

FIG. 7 is a ranking of transportation modes for each of the mobility attributes in accordance with an embodiment.

FIG. 8 depicts an exemplary multiple-criteria decision modeling analysis for transportation modes in accordance with an embodiment.

FIG. 9 is a flow chart of a method of selecting transportation modes for transportation needs in accordance with an embodiment.

### DETAILED DESCRIPTION

### Overview

The systems and methods disclosure herein are configured to use multiple-criteria decision making (MCDM) analysis and linear programming to optimize a ranking of a plurality of transportation modes for a transportation need based on a ranking of mobility attributes associated with the transportation need and available transportation modes. In some embodiments, the plurality of transportation modes includes use of a personally owned vehicle, use of third-party transit such as a taxi or ride-hailing service, and use of a personally owned vehicle for personal and third-party transit. In various embodiments, the transportation modes are ranked in view of one or more mobility attributes associated with a transportation need.

In one example embodiment, the one or more mobility attributes associated with a transportation need can include trip reliability, essentialness, flexibility, distance, time, frequency, cost, alternatives, privacy, safety, security, productivity, freedom, and family requirements. Available mobility attributes are not intended to be limited to those attributes described herein. In certain instances, additional mobility attributes associated with the characteristics of the transportation need can be considered. In one embodiment, the mobility attributes can be ranked in order of importance relative to the transportation need desired. Certain transportation needs, such as commuting to and from work, may require certain mobility attributes while other transportation needs, such as shopping and household transportation, may require other mobility attributes. In various embodiments, the mobility attributes for each transportation need can be ranked in view of localized norms (e.g., community norms and values), aggregate norms (e.g., task dependent criteria), or other ranking criteria. Although safety and security can be ranked, these mobility attributes will in almost all circumstances be given the highest ranking possible. In some instances, if these attributes are ranked lower, it will be by the consumer and not necessarily the transportation company.

In one embodiment, MCDM analysis and linear programming can be utilized to rank the transportation modes in view of the mobility attributes associated with the transportation need. This and other advantages of the present disclosure are provided in greater detail herein.

### Illustrative Embodiments

In an embodiment, a method of selecting transportation modes for transportation needs may include receiving information at a processing circuitry, the information associated with the transportation need. The method can further include ranking a plurality of mobility attributes associated with the transportation need and performing multiple-criteria decision making (MCDM) analysis and linear programming using the ranking of the plurality of mobility attributes and available transportation modes. In view of MCDM analysis and linear programming, the method can further rank the available transportation modes for the transportation need. In a further embodiment, the method can include communicating the ranking of transportation modes to a device associated with the transportation mode (e.g., a user smart device).

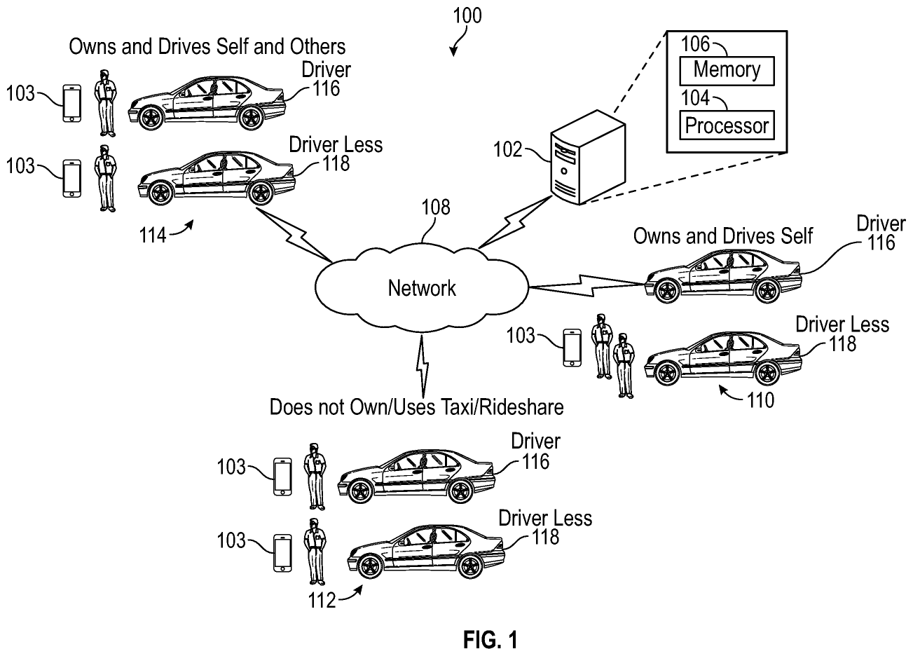

Turning now to the drawings, FIG. 1 depicts a transportation system 100 including a device 102, such as a computing device, including processing circuitry 104 coupled to memory storage 106. The device 102 can include a hardware stored local to a vehicle or remotely, e.g., via cloud communication. The device 102 can be in communication with a network 108. The network 108 can be associated, for instance, with a cloud server. Each user of the transportation system 100 may include a mobile device 103 or the like for interacting with the transportation system 100.

The network 108 can be in communication with one or more vehicles, such as for instance, vehicles 110 associated with transportation scenarios where one or more individuals owns and drives the vehicle for personal transportation. In another embodiment, the network 108 can be in communication with one or more vehicles, such as for instance, vehicles 112 associated with transportation scenarios where a passenger does not own a vehicle but utilizes the vehicle for transportation. Such scenarios may include vehicles 112 associated with taxi services and ride sharing services. In certain embodiments, vehicles 112 can be utilized simultaneously by more than one party associated with a transportation need. In yet another embodiment, the network 108 can be in communication with one or more vehicles, such as for instance, vehicles 114 associated with transportation scenarios where one or more individuals owns and drives a vehicle for personal transportation and for the transportation of others. Vehicles 114 may be utilized, for example, as part of ride sharing services and personal use.

In some embodiments, at least one of the vehicles 110, 112, and 114 may be driven by a human driver 116. In other embodiments, at least one of the vehicles 110, 112, and 114 may be driverless (e.g., autonomous vehicle) 118. In yet other embodiments, at least one of the vehicles 110, 112, and 114 can be driven by a human driver and at least one of the vehicles 110, 112, and 114 can be driverless. In certain instances, vehicles 110, 112, and 114 of different or same vehicle types can be in simultaneous communication with the network 108. For example, a driverless vehicle 114 can be in communication with the network 108 while a human driven vehicle 110 is simultaneously in communication with the network 108.

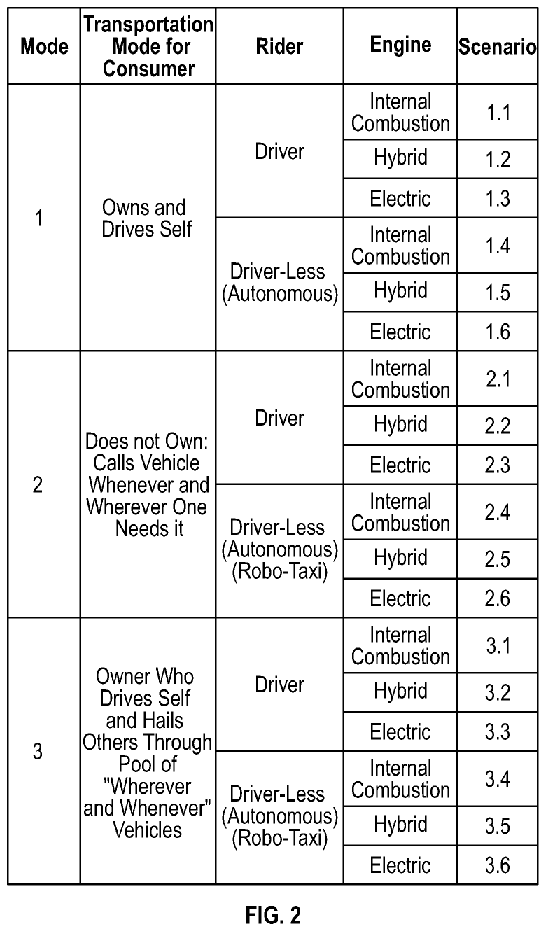

FIG. 2 is an illustrative listing of various transportation modes. The transportation modes are proposed for vehicles used today and in the future. The transportation modes include consumer owned vehicles used to drive the consumer for their own transportation needs. The transportation modes further include instances where the consumer does not own a vehicle but instead uses a taxis or ride-hailing service whenever and wherever their transportation need arises. The transportation modes can further include instances where the consumer owns a vehicle and drives themselves for their transportation needs in addition to providing ride-hailing services to others for their transportation needs whenever and wherever they may arise.

The vehicles are considered to be driven today and in the future by either human drivers or through automation (e.g., autonomous vehicles). As noted in FIG. 2, all three transportation modes are considered with a driver and driver-less (e.g., autonomous or robo-taxi). The vehicles are considered to be powered by internal combustion engines running on either gasoline or diesel fuel, hydrogen, fuel cells, LPG, natural gas, etc. electric vehicles, and hybrid vehicles including a combination of internal combustion engines and electric power. Any alternative power source may be used.

The three transportation modes are considered in view of driver and driver-less operation in further view of engine type, resulting in eighteen possible scenarios (e.g., ride-hailing a human driven vehicle running on an internal combustion engine—Scenario 2.1 vs. a self-owned driver-less vehicle running on an electric motor—Scenario 1.6). It should be understood that alternative combinations might be considered. Further, additional distinctive characteristics can be identified such as vehicle size (e.g., sedan vs. minivan). As a result, the number of possible scenarios may change and is not intended to be limited to those exemplary scenarios described herein.

In selecting an appropriate transportation mode for a transportation need, the parameters that influence the individual to select a particular transportation mode must be considered. For a majority of consumers, transportation needs can be categorized into five basic categories: travel to and from work or school, travel to and from groceries or shopping, running errands, traveling for special trips (e.g., entertainment outings, doctor visits, etc.), and traveling for vacation. Each of these categories has particular mobility attributes associated therewith. Exemplary attributes associated with these categories are listed in Table 1. The listing of exemplary attributes should be understood to be non-limiting and may include different characteristics or values associated therewith. Where a mobility attribute is not rated or described for a transportation need, the importance of that attribute is considered minimal for the associated need.

TABLE 1
Exemplary mobility attributes associated with transportation needs

| Cate- | Transportation | |
|---|---|---|
| gory | Need | Mobility Attributes |
| A | Work or school | Essential: The need is essential for earning |
| | | or education |
| | | Reliability: High degree of reliability needed |
| | | Flexibility: No |
| | | Distance: 20-50 miles per day |
| | | Trip Time: 20-50 minutes |
| | | Frequency: 5 days per week |
| | | Cost: High importance |
| | | Alternative: Minimal |
| | | Privacy: Transportation can be pooled |
| | | Safety: |
| | | Security: |
| | | Productivity: |
| | | Freedom: |
| | | Family Transport: |
| B | Grocery or | Essential: The need is essential for sustenance |
| | shopping | Reliability: Low degree of reliability needed |
| | | Flexibility: Yes |
| | | Distance: 10-20 miles |
| | | Trip Time: 10-30 minutes |
| | | Frequency: 1-2 days per week |
| | | Cost: Low importance |
| | | Alternative: Order online for delivery |
| | | Privacy: Needed, pooling unlikely |
| | | Safety: Important consideration |
| | | Security: Important consideration |
| | | Productivity: |
| | | Freedom: |
| | | Family Transport: Important consideration |
| C | Errands | Essential: The need is non-essential |
| | | Reliability: Low degree of reliability needed |
| | | Flexibility: Yes |
| | | Distance: 10-20 miles |
| | | Trip Time: 30-60 minutes |
| | | Frequency: 3-5 days per week |
| | | Cost: Low importance |
| | | Alternative: Can be combined with other needs |
| | | Privacy: Needed, pooling unlikely |
| | | Safety: Important consideration |
| | | Security: Important consideration |
| | | Productivity: |
| | | Freedom: |
| | | Family Transport: Important consideration |
| D | Special | Essential: The need is essential |
| | Trips | Reliability: High degree of reliability needed |
| | | Flexibility: No |
| | | Distance: 10-20 miles |
| | | Trip Time: 30-60 minutes |
| | | Frequency: 1-2 days per week |
| | | Cost: Low importance |
| | | Alternative: No |
| | | Privacy: Needed, pooling unlikely |
| | | Safety: Important consideration |
| | | Security: Important consideration |
| | | Productivity: |
| | | Freedom: |
| | | Family Transport: Important consideration |
| E | Vacation | Essential: The need is non-essential |
| | | Reliability: High degree of reliability needed |
| | | Flexibility: Yes |
| | | Distance: Long |
| | | Trip Time: Long |
| | | Frequency: Infrequent and irregular |
| | | Cost: Low importance |
| | | Alternative: No |
| | | Privacy: Needed, pooling unlikely |
| | | Safety: Important consideration |
| | | Security: Important consideration |
| | | Productivity: |
| | | Freedom: |
| | | Family Transport: Important consideration |

The exemplary mobility attributes described in Table 1 are estimates that may change with variable local and aggregate norms. In various embodiments, mobility attributes can be determined by polling relevant sample sizes of the population. In certain instances, sample size can be determined by local community standards. For example, sample size can include preferences and normalized data compiled from individual neighborhoods, communities, or regional groups. In other instances, sample size can include aggregate data compiled from non-localized sample groups. For instance, the sample size can include national or global mobility attribute considerations.

For the mobility attributes of the consumers, there are eighteen contemplated transportation scenarios listed in FIG. 2. Additionally, there are five transportation needs and fourteen mobility attributes per Table 1.

After determining appropriate mobility attributes, the contemplated transportation modes for each transportation need can be determined based on the mobility attributes. In an embodiment, the ranking of transportation modes can be performed using quantitative analysis. For example, the quantitative analysis can factor in considerations such as cost per mile associated with each transportation mode. The cost per mile can account for expenses such as the lifecycle cost attributed with vehicle ownership, such as the cost to purchase a vehicle, charges for registration and insurance, costs to operate and maintain the vehicle, and monthly payments to finance automobile purchases. While many of the costs attributed with vehicle ownership are similar for vehicles running on internal combustions engines, hybrids, and electric vehicles, there are differences in costs between operating these vehicles, such as purchase price, and operation and maintenance costs. The operating cost for vehicles utilizing internal combustion engines may be determined based on the miles driven and the fuel used. The mileage may be different for hybrid vehicles and thus operating costs would be less than internal combustion vehicles. The mileage of electric vehicles can be determined as an equivalent-miles per gallon or miles driven per kilo-watt-hour of electric power consumed. As electric vehicles have fewer moving parts than internal combustion vehicles, the cost of maintenance would be different, and is estimated to be less than internal combustion engine vehicles. One additional cost that might be considered for human driven vehicles is the owner's time spent driving the vehicle. It may be possible to assume an hourly rate for the owner's time driving the vehicle and estimate the lifetime driver time-cost expense. In such a manner, autonomous vehicles can additionally be compared against non-autonomous vehicles in determining the optimized transportation mode ranking.

In one embodiment, the quantitative analysis may return a quantitative result, such as a determined cost required per mile of operation.

In another embodiment, the ranking of transportation modes can be performed using qualitative analysis. For example, the qualitative analysis can factor in the mobility attributes associated with the transportation need and as exemplary described in Table 1. The qualitative ranking can be performed using a multiple criteria decision making (MCDM) analysis technique. MCDM analysis can be used to evaluate multiple conflicting criteria when making decisions. Using MCDM analysis, conflicting criteria can be evaluated both quantitatively and qualitatively. Because of a finite number of mobility attributes, transportation modes, and transportation needs, MCDM analysis can be used to determine and sort relative options with respect to one another and generate a ranking of those options. In one embodiment, the ranking can be based at least in part on the mobility attributes associated with the transportation need. In another embodiment, the ranking can be further based at least in part on the available transportation modes. The resulting information can be used to ascertain best options for transportation modes in view of a transportation need and associated mobility attributes.

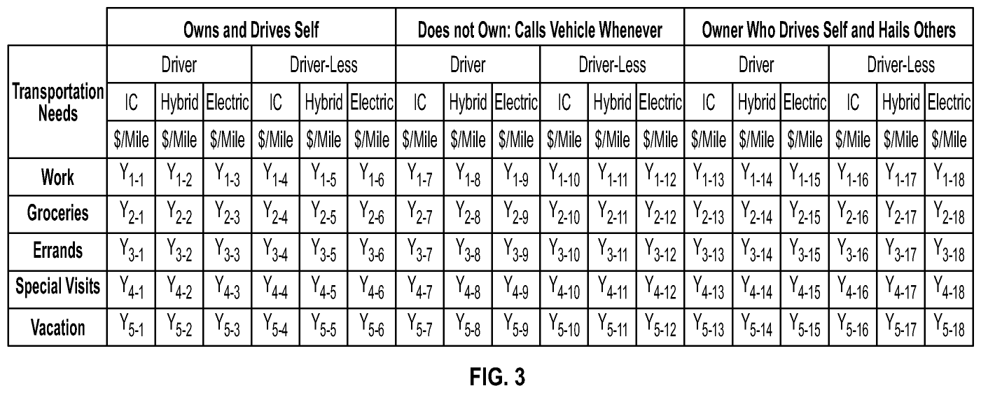

FIG. 3 illustrates an exemplary decision-making matrix ranking the transportation modes. The ranking is identified as variable Yⱼ₋ₖ. The variable Yⱼ₋ₖ can be defined for each transportation mode k and for each transportation need j. The MCDM analysis can calculate the value of the variable Yⱼ₋ₖ in view of the number of available transportation modes k and transportation needs j. For instance, in the exemplary decision-making matrix, Yⱼ₋ₖ can range from 1 to 18 with 1 being the most preferred mode of transportation and 18 being the least preferred mode of transportation for a given transportation need. As further illustrated in FIG. 3, the quantitative analysis (e.g., cost per mile associated with each transportation mode) can be included as part of the analysis in the decision-making matrix.

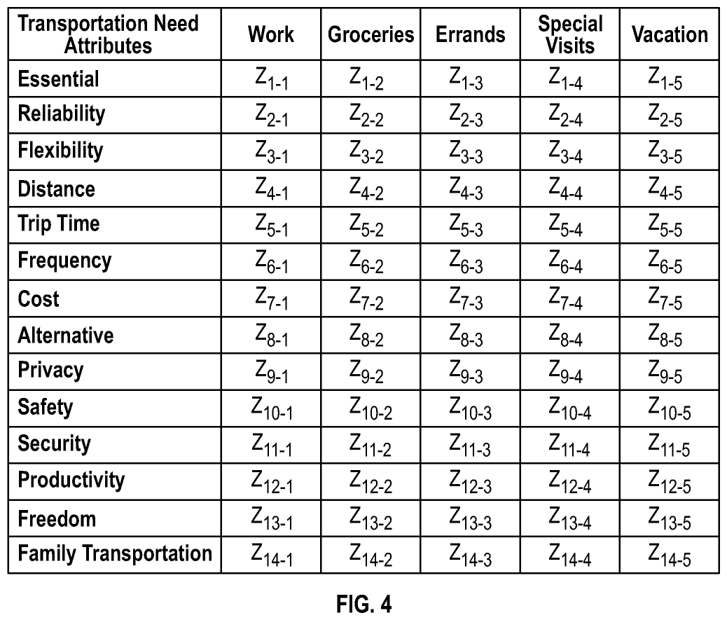

FIG. 4 depicts a matrix ranking the mobility attributes for each transportation need. The ranking is identified as variable Zᵢ₋ⱼ. The variable can be defined for each transportation need j and for each mobility attribute i. In an embodiment, the variable can be ranked with values in accordance with the available transportation need j and the number of mobility attributes i being considered. In the exemplary matrix illustrated in FIG. 4, the variable can include rankings with values ranging from 1 to 14, with 1 being the most important mobility attribute consideration and 14 being the least important consideration for a given transportation need i.

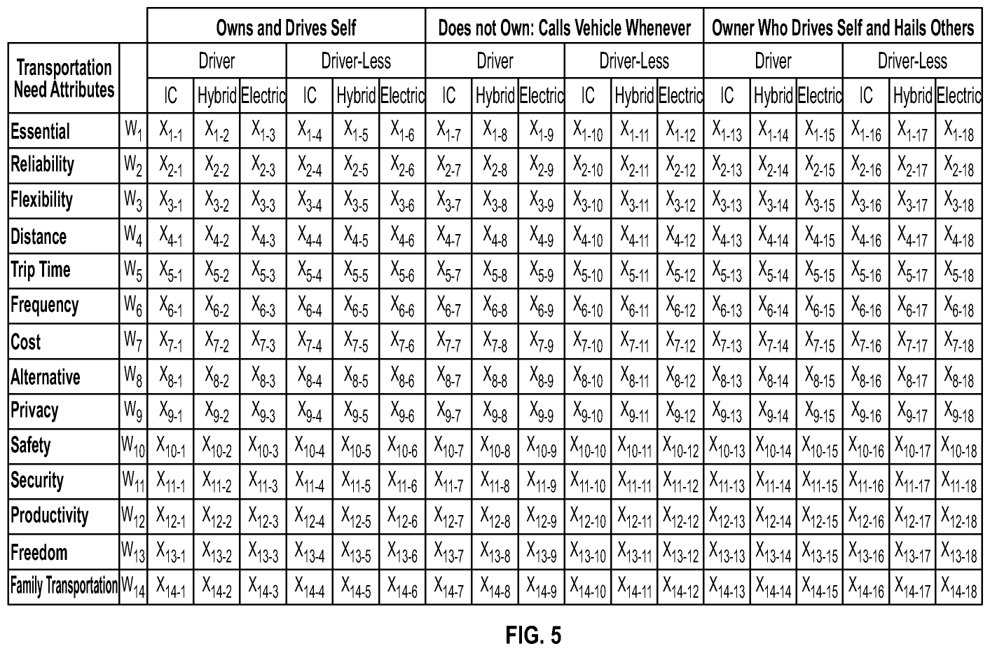

FIG. 5 depicts a matrix ranking transportation modes for contemplated mobility attributes. The ranking is identified as variable Xⱼ₋ₖ. In an embodiment, the variable Xⱼ₋ₖ can be defined for each transportation mode k and for each mobility attribute i. The variable Xⱼ₋ₖ can be ranked with values in accordance with the number of available transportation modes k and the number of contemplated mobility attributes i. In the exemplary embodiment depicted in FIG. 5, there are 18 transportation modes and 14 mobility attributes. The variable Xⱼ₋ₖ can be ranked with values ranging from 1 to 18, with 1 being the most preferred mode and 18 being the least preferred mode in view of a given mobility attribute.

FIG. 5 further illustrates a weighting wᵢ of each mobility attribute. For a given transportation need, the mobility attributes can be first ranked in similar order as variable Zᵢ₋ⱼ for that specific transportation need. This ranking of mobility attributes can permit higher weightings of the higher ranked mobility attributes. The weights wᵢ of each mobility attribute can be determined using linear programming optimization.

In one embodiment, linear programming can be performed using the following modeling analysis. For each transportation need j, the analysis can seek to minimize Yⱼ₋ₖ=ΣwᵢXᵢ₋ₖ, where k is the transportation mode based on all of the attributes i of the transportation need j using weights wᵢ of that attribute. The weights wᵢ of the attributes can be considered from the decision variables that the linear programming calculates using the multiple criteria decision making (MDCM) analysis constraints. For each transportation need, the minimum ranking of the transportation mode can be based on the multiple attributes of that transportation need.

TABLE 2
Constraints for Multiple Criteria
Decision Making (MCDM) analysis

| | |
|---|---|
| Σ wᵢ = 1 | The sum of all weights is equal to 1. |
| wᵢ ≥ 0.001 | Each weight is non-zero with a minimum value of 0.001. |
| _{wi-1} − wᵢ ≥ 0 | For a given transportation need, the attributes are |
| | ranked in similar order as variable Zᵢ₋ⱼ for that need. |
| | w₁ is the weight of the most important attribute for |
| | a transportation need and wᵢ is the least |
| | important attribute. |
| Σ wᵢXᵢ₋ₖ ≤ k | Weighted value of the k^{th} transportation |
| | mode cannot be more than the total number of |
| | transportation modes. |

Table 2 illustrates exemplary constraints used in performing linear programming to determine a best transportation mode for each transportation need in view of mobility attributes and weights.

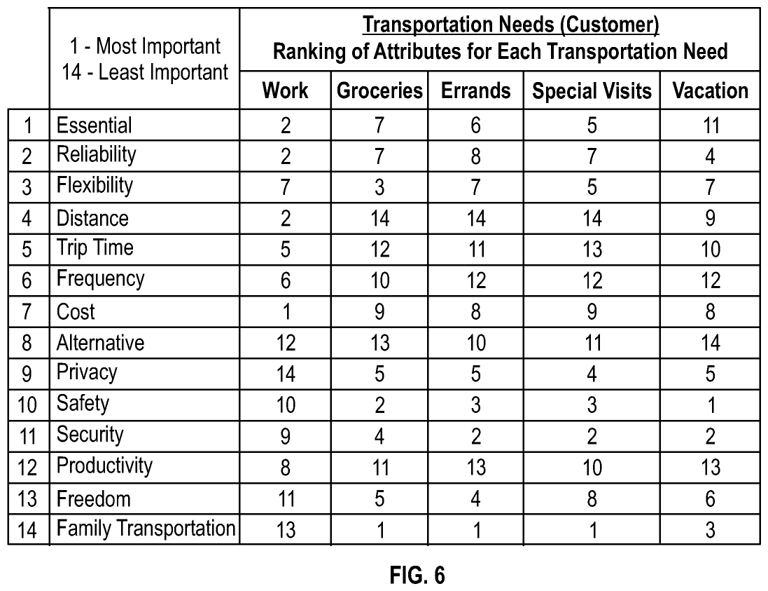

FIG. 6 illustrates a ranking of mobility attributes for transportation needs. By way of exemplary embodiment, the mobility attributes for each of the transportation needs were ranked from 1 to 14. The rankings were then assigned to variables Zᵢ₋ⱼ, with 1 being the most important mobility attribute and 14 being the least important mobility attribute.

FIG. 6 illustrates that the mobility attributes for each transportation need are different. For instance, transportation needs associated with work were determined to have a high importance mobility attribute associated with cost, closely followed by essentialness, reliability, and distance. To the contrary, the transportation needs associated with groceries and errands had a high importance mobility attribute associated with family transportation. This importance leads to high mobility attribute considerations of privacy, safety and security. The cost criteria of transportation needs associated with groceries and errands was determined to be lower than the cost criteria for the work mobility attribute. Similarly, the frequency of trips for groceries and errands was determined to be lower than the transportation need of special visits. While the frequency was found to be low for special visits, the need for safety, security, and privacy were determined to be highly important. Special visits were also determined to require a high ranking for essentialness and a need for high reliability. Cost was not a significant selection criteria for special visits. It should be understood that other groups surveyed may determine different mobility attributes and rankings associated with each of the transportation needs. The results determined herein are merely used for exemplary purposes and are not meant to be limiting.

### CURRENT EXAMPLE

Assume a vehicle purchase price is $50,000. Using average finance charges, the monthly average payment on the vehicle would be $485. With other costs being considered (e.g., fuel cost, maintenance, etc.) the calculated cost to own a vehicle can thus range from $1.20 per mile to $1.43 per mile.

The cost per mile associated with taxi services was determined using information associated with The Yellow Cab. The cost per mile attributes include minimum first mile charges, rates per mile of use driving after the first mile and wait times per minute. Additional costs such as tip can be determined. The calculated cost to use a taxi service was estimated at $2.73 per mile.

The cost per mile associated with the use of third-party ride hailing apps was determined using information associated with Uber. The cost per mile attributes include a base fare, booking fee, per minute charge, and per mile charge. Additional costs such as tip can further be determined. The calculated cost to use a ride-hailing app was estimated at $3.39 per mile.

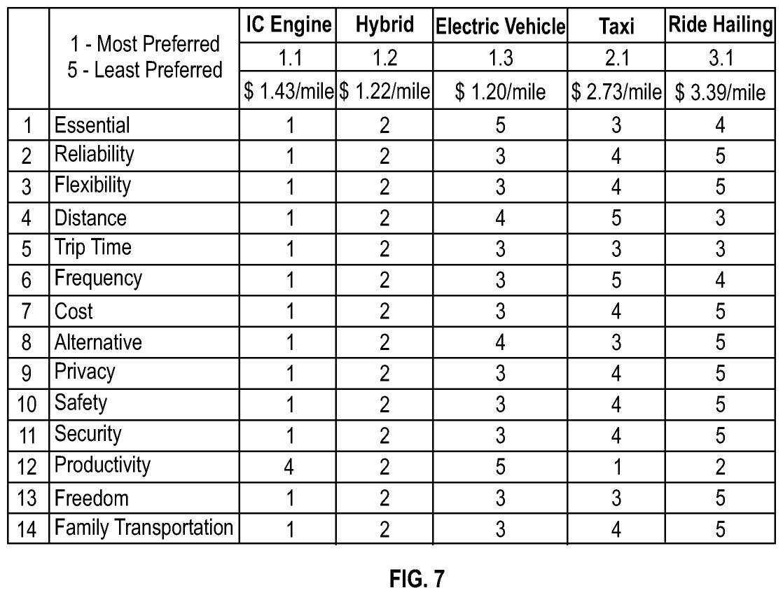

FIG. 7 depicts a ranking of transportation modes using variable Xᵢ₋ₖ with values ranging from 1 to 5, where 1 is the most preferred mode of transportation and 5 is the least preferred mode of transportation for given mobility attributes associated with the transportation need. As illustrated, vehicle ownership was determined as preferential over taxis and ride hailing services for almost all of the mobility attributes. However, if productivity is a key consideration during a ride for the transportation need then a taxi or ride-hailing service was the most preferred transportation mode. Of course, these rankings change over time and might vary between communities and cultural regions.

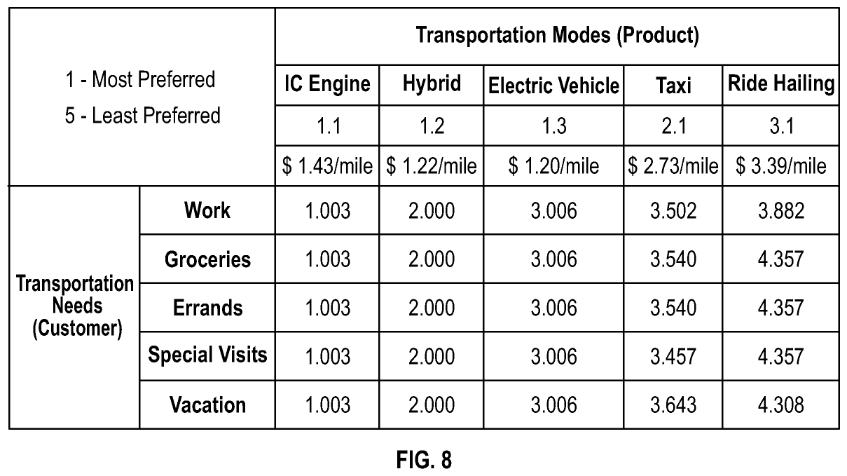

FIG. 8 depicts results of linear programming for the transportation modes in view of transportation needs. FIG. 8 illustrates both qualitative and quantitative analysis. From the figure, it can be seen that scenario 1.3 of owning an electric vehicle is the lowest cost per mile option while scenario 3.1 of ride-hailing is the most expensive option. However, while ranking the options qualitatively, the figure shows that scenario 1.1 of owning an internal combustion engine vehicle is the most preferred transportation mode while scenario 3.1 of ride hailing is the least preferred option. As previously noted, these results may change upon determination of different mobility attribute rankings and over time as vehicle ownership and operation costs change.

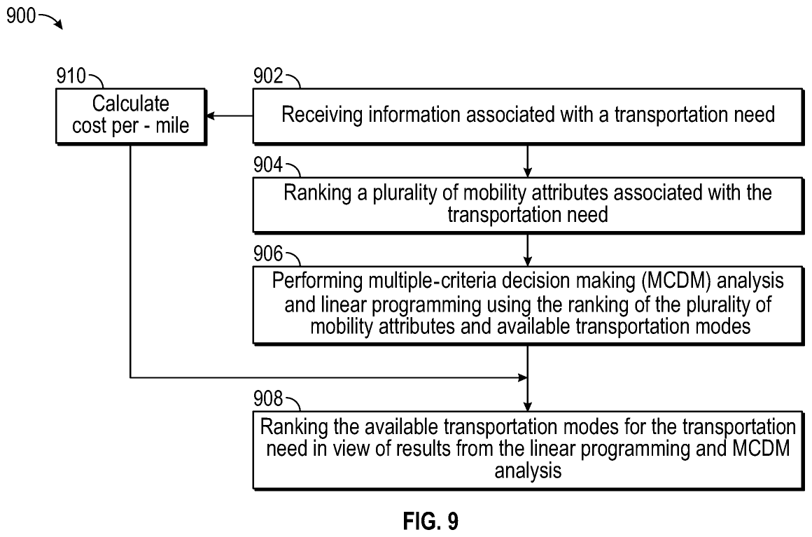

FIG. 9 illustrates a method 900 of selecting transportation modes for transportation needs. In an embodiment, the method 900 includes receiving 902 information associated with a transportation need and ranking 904 a plurality of mobility attributes associated with the transportation need. The method 900 can further include performing multiple-criteria decision making (MDCM) analysis and linear programming 906 using the ranking of the plurality of mobility attributes and available transportation modes. In some instances, the cost per mile 910 may be calculated. In an embodiment, the method 900 can further include ranking 908 the available transportation modes for the transportation need in view of results from the linear programming and MCDM analysis and the costs per mile. The ranking 908 can be used by auto manufactures or transportation providers to market or suggest preferred transportation modes to users.

This disclosure may, however, be embodied in many different forms and should not be construed as limited to the exemplary embodiments set forth herein. It will be apparent to persons skilled in the relevant art that various changes in form and detail can be made to various embodiments without departing from the spirit and scope of the present disclosure. Thus, the breadth and scope of the present disclosure should not be limited by any of the above-described exemplary embodiments but should be defined only in accordance with the following claims and their equivalents. The description below is presented for the purposes of illustration and is not intended to be exhaustive or to be limited to the precise form disclosed. Alternate implementations may be used in any combination desired to form additional hybrid implementations of the present disclosure.

Device characteristics described with respect to one feature of the present disclosure may provide similar functionality in other devices. For example, any of the functionality described with respect to a particular component such as a first processor in a first computer may be performed by another component such as a second processor in another computer. Further, although embodiments have been described in language specific to structural features and/or methodological acts, it is to be understood that the disclosure is not necessarily limited to the specific features or acts described.

In the above disclosure, reference has been made to the accompanying drawings that illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “exemplary” as used herein indicates one among several examples, and it should be understood that no undue emphasis or preference is being directed to the particular example being described. Certain words and terms are used herein solely for convenience and such words and terms should be interpreted as referring to various objects and actions that are generally understood in various forms and equivalencies by persons of ordinary skill in the art.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not intended to imply that features, elements, and/or steps are in any way required for one or more embodiments.

It is anticipated and intended that future developments will occur in the technologies discussed herein, and that the disclosed systems and methods will be incorporated into such future embodiments. In sum, it should be understood that the application is capable of modification and variation.

That which is claimed is:

1. A method, comprising:
receiving, by a computing device, information associated with a transportation need;
determining, by the computing device, a plurality of mobility attributes associated with the transportation need;
ranking, by the computing device and based on the transportation need, the plurality of mobility attributes;
performing, by the computing device, multiple-criteria decision making (MCDM) analysis and linear programming using the ranking of the plurality of mobility attributes and available transportation modes; and
ranking, by the computing device, the available transportation modes for the transportation need in view of results from the linear programming and MCDM analysis.

2. The method of claim 1, further comprising communicating the ranking of the transportation modes to a device associated with the transportation need.

3. The method of claim 1, wherein the plurality of mobility attributes comprises at least two of trip reliability, essentialness, flexibility, distance, time, frequency, cost, alternatives, privacy, safety, security, productivity, freedom, and family requirements.

4. The method of claim 1, wherein the transportation modes comprise use of a personally owned vehicle, use of third-party transit, and use of a personally owned vehicle for personal and third-party transit.

5. The method of claim 1, wherein MCDM analysis is performed using a finite number of known alternative mobility attributes and a finite number of transportation modes.

6. The method of claim 1, wherein MCDM analysis is performed to minimize Yⱼ₋ₖ=ΣwᵢXᵢ₋ₖ, wherein Yⱼ₋ₖ is the ranking of the transportation modes for the transportation need, wherein Σwᵢ=1, wherein wᵢ≥0.001, wherein wᵢ₋₁−wᵢ≥0, and wherein ΣwᵢXᵢ₋ₖ≤k.

7. A transportation system comprising:
a processor; and
a computer-readable memory comprising program instructions that, when executed, cause the processor to:
rank a plurality of mobility attributes based on a transportation need; and
use multiple-criteria decision making (MCDM) analysis and linear programming to optimize a ranking of a plurality of transportation modes for the transportation need based on the ranking of mobility attributes associated with the transportation need and available transportation modes.

8. The transportation system of claim 7, further comprising a communication element configured to communicate the optimized ranking of the plurality of transportation modes to a user device associated with the transportation need.

9. The transportation system of claim 7, wherein the transportation need comprises at least one of transportation to work or school, transportation to shopping areas, transportation for errands, transportation for a specialized trip, and transportation for vacation.

10. The transportation system of claim 7, wherein the mobility attributes include at least two of need-based reliability, essentialness, flexibility, distance, time, frequency, cost, available alternatives, privacy, safety, security, productivity, freedom, and family requirements.

11. The transportation system of claim 7, wherein the transportation modes comprise use of a personally owned vehicle, use of third-party transit, and use of a personally owned vehicle for personal and third-party transit.

12. The transportation system of claim 7, wherein MCDM analysis is performed to minimize Yⱼ₋ₖ=ΣwᵢXᵢ₋ₖ, wherein Yⱼ₋ₖ is the ranking of the transportation mode k for a transportation need j, wherein Σwᵢ=1, wherein wᵢ≥0.001, wherein wᵢ₋₁−wᵢ≥0, and wherein ΣwᵢXᵢ₋ₖ≤k.

13. The transportation system of claim 7, wherein the MCDM analysis and linear programming are configured to provide qualitative and quantitative analysis of each transportation mode for the transportation need.

14. A device, the device comprising processing circuitry coupled to storage, the processing circuitry configured to:
receive information associated with a transportation need;
rank of a plurality of mobility attributes based on the transportation need;
perform multiple-criteria decision making (MCDM) analysis and linear programming using the ranking of the plurality of mobility attributes and available transportation modes; and
rank the available transportation modes for the transportation need in view of results from the linear programming and MCDM analysis.

15. The device of claim 14, further comprising a communication element configured to communicate the ranking of the available transportation modes to a user device associated with the transportation need.

16. The device of claim 14, wherein the transportation need comprises at least one of transportation to work or school, transportation to shopping areas, transportation for errands, transportation for a specialized trip, and transportation for vacation.

17. The device of claim 14, wherein the mobility attributes include at least two of need-based reliability, essentialness, flexibility, distance, time, frequency, cost, available alternatives, privacy, safety, security, productivity, freedom, and family requirements.

18. The device of claim 14, wherein the transportation modes comprise use of a personally owned vehicle, use of third-party transit, and use of a personally owned vehicle for personal and third-party transit.

19. The device of claim 14, wherein ranking of available transportation modes is performed to minimize Yⱼ₋ₖ=ΣwᵢXᵢ₋ₖ, wherein Yⱼ₋ₖ is the ranking of the transportation mode k for a transportation need j, wherein Σwᵢ=1, wherein wᵢ≥0.001, wherein wᵢ₋₁−wᵢ≥0, and wherein ΣwᵢXᵢ₋ₖ≤k.

20. The multiple-criteria decision making of claim 13, wherein the MCDM analysis and linear programming are configured to provide qualitative and quantitative analysis of each available transportation mode for the transportation need.
